(19) United States
(12) Patent Application Publication
(10) Pub. No.: US 2004/0163759 A1
(43) Pub. Date: Aug. 26, 2004

(54) DECORATIVE GLASS BLOCK

(76) Inventor: Thomas C. Wilkinson, Santa Barbara, CA (US)

Correspondence Address: Michael G. Petit, P.O. Box 91929, Santa Barbara, CA, 93190-1929, US

(21) Appl. No.: 10/376,372

(22) Filed: Feb. 26, 2003

(51) Int. Cl. B32B 31/00

(52) U.S. Cl. 156/254

(57) ABSTRACT

A method for making a decorative glass block bearing a design. A preferred embodiment of the method comprises the steps of: (a) presenting a prior art hollow glass block comprising a generally rectangular body having an optically transparent front surface, an optically transparent rear surface disposed parallel to the front surface wherein the front surface is identical to the rear surface, and rectangular sides disposed between and supporting the front and rear surfaces; then (b) cutting the rectangular sides to separate the prior art hollow glass block into two disconnected semiblocks, each of the two semiblocks being a mirror image of the other; then (c) inserting a transluscent sheet bearing a design between the cut edges of the two semiblocks and adhering the sheet to the two semiblocks by adhesive means, the translucent sheet being sandwiched therebetween. The adhesive joint is not visible through the front surface.

### BACKGROUND OF THE INVENTION

1. Field of the Invention

The present invention relates to a decorative glass block and, more particularly, to a method for constructing a decorative glass block.

2. Prior Art

Hollow glass blocks are well known in the art and have been employed as a decorative building material for at least sixty years. Such prior art glass blocks are generally molded in two mirror image halves and joined in a separate step. Early blocks had no means for reducing glare from sunlight. To overcome this problem, Rapp, et al., in U.S. Pat. No. 2,322,591, discloses glass blocks incorporating a louvered filter screen therein operable for reducing glare. The method for making the glass blocks in accordance with Rapp, et al. requires changing the customary glass block production methods used in the art. The method proposed by Rapp, et al. requires the soldering of a louvered section to one half of the block prior to or during fusion of the two halves which substantially increases the cost of production.

Mass produced glass blocks in accordance with the prior art have enjoyed limited utility because, due at least in part to the method used in the art for mass production, they lacked color and such glass blocks are not readily adaptable for displaying customized artistic renderings. Uhlik, in U.S. Pat. No. 5,333,427, discloses a hollow, molded glass block having box-like lateral walls of unitary construction, and a central panel which extends throughout the area bounded by, and joining the interior facing surfaces of the enclosing walls. The central panel is preferably formed with a surface which accepts decals. The glass block is constructed by first molding the rectangular frame and the central panel as a unitary structure. Decorative indicia is applied to the central panel, then the central panel is enclosed by fusing parallel glass plates to the edges of the frame. Again, as in the Rapp, et al. block, the production method requires new molds and two separate joining steps for attachment of the parallel glass plates to the frame.

Ashby, et al., in U.S. Pat. No. 5,160,566, discloses a hollow structural glass block that is slotted by cutting or grinding to allow the installation of a specifically sized decorative panel insert through the slot into the interior of the block. The decorative insert panel is preferably comprised of stained, iridescent, or etched glass. A bead of clear silicone rubber caulking is applied to the bottom edge of the insert panel prior to slipping the panel through the slot. The silicone rubber caulking functions as an adhesive to secure and stabilize the bottom edge of the insert to the bottom interior of the block. The top edge of the insert is positioned between the edges of the block defining the slot. The slot, and the top exposed edge of the insert lying therein is covered with a layer of clear silicone rubber to secure the insert and seal the interior of the glass block against the entrance of moisture and mortar. It is an advantage that a decorative glass block made in accordance with the Ashby et al. patent uses standard, mass-produced glass blocks. Because the blocks are hollow, when inserting the panel through the slot, which is cut in only one edge of the block, it is, in practice, difficult to position the bottom edge of the inserted panel centrally for adhesive attachment to the opposing edge of the block. Further, the silicone rubber joint on the bottom edge of the inserted panel is visible through the wall of the block and detracts from the appearance of the block.

There is a need for a method for making decorative custom glass blocks that enables a fabricator to use mass produced blocks to produce glass blocks having a color, texture or design therewithin, is easy to use and provides an aesthetically pleasing product that can be used either as a stand-alone work of art or as part of a wall or similar architectural structure.

### SUMMARY

It is an object of the present invention to provide an inexpensive method for modifying mass-produced glass blocks to make customized decorative glass blocks.

The features of the invention believed to be novel are set forth with particularity in the appended claims. However the invention itself, both as to organization and method of operation, together with further objects and advantages thereof may be best understood by reference to the following description taken in conjunction with the accompanying drawings.

### BRIEF DESCRIPTION OF THE DRAWINGS

FIG. 1 is a perspective view of a mass-produced glass block in accordance with the prior art.

FIG. 2 is a perspective view of the glass block of FIG. 1 sawed in half in accordance with the method of the present invention.

FIG. 3 is a front perspective view of a decorative panel for incorporation within a split prior art glass block to provide a decorative glass block.

FIG. 4 is a front view of a decorative glass block made in accordance with the method of the present invention.

### DESCRIPTION OF THE PREFERRED EMBODIMENTS

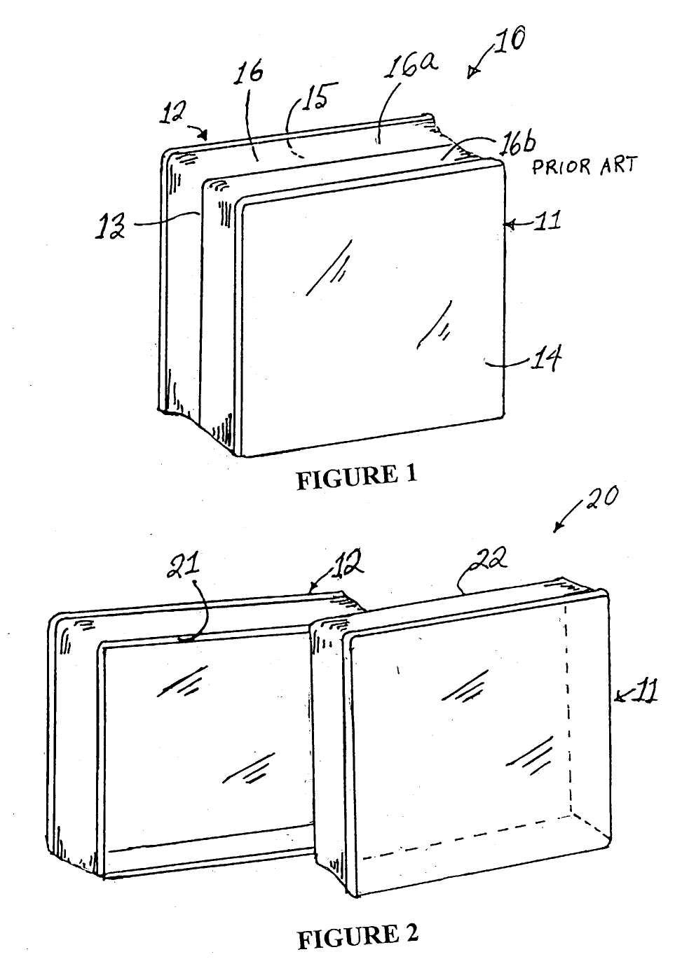

FIG. 1 is a perspective view of a mass-produced glass block in accordance with the prior art. The prior art glass block 10 is unitary in construction and comprised of a front half-block 11 and a rear half-block 12 fused to one another along a joint 13 to form a hollow, box-like glass block 10 as shown. The block 10 has a substantially planar front face 14 and a rear face 15 disposed parallel to the front face 14. The joint 13 divides the top edge 16 into a rear top edge 16a and a front top edge 16b.

FIG. 2 is a perspective view of the glass block of FIG. 1 sawed in half along joint 13 to form semiblocks 11 and 12 in accordance with the method of the present invention. The semiblocks comprise a rear half 11 and a front half 12 that is a mirror image of the rear half 11. The semiblocks 11 and 12 have parallel, flat saw-cut edges 21 and 22.

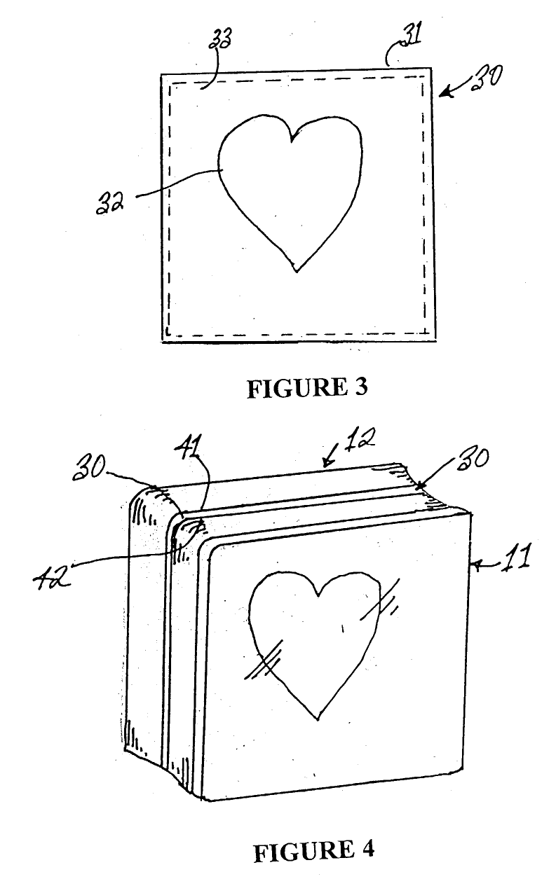

FIG. 3 is a front perspective view of a decorative panel 30 for incorporation between the semiblocks 11 and 12 of split prior art glass block 10 to provide a decorative glass block 40 (FIG. 4) in accordance with the present invention. The decorative panel 30 comprises a flat sheet 31 of a transluscent material having a visual image 32 thereon. The image 32 may be etched, painted or silkscreened on the sheet 31 or transferred thereto by an applique. After the panel 30 is prepared, the peripheral edges 33 of the front and rear surfaces, represented by a dotted line in the dwawing, may be primed in preparation for adhesive attachment to the edges 21 and 22 of semiblocks 11 and 12.

FIG. 4 is a front perspective view of a decorative glass block 40 made in accordance with the method of the present invention. A bead of adhesive such as silicone rubber or Canada balsam is applied to the peripheral edges 33 of the sheet 30 and/or the saw-cut edges 21 and 22 of the semiblocks 11 and 12 and the sheet 30 sandwiched between the saw-cut edges and pressed together with clamping means until the adhesive cures. The block 40 is ready for use either as a stand-alone decorative piece or for incorporation into a structural unit comprised of a plurality of glass blocks. If the thickness of the saw-cut is substantially the same as the thickness of the sheet 30, the decorative glass block 40 may be incorporated into a structure comprised of either prior art glass blocks 10 and/or a plurality of decorative glass blocks 40.

A second method for making a decorative glass block bearing a design can be employed which hides the adhesive joint between the panel or sheet bearing the design and the block. In this second method, a prior art hollow glass block comprising a front surface, a rear surface substantially identical to the front surface and disposed parallel to the front surface, and spaced therefrom along the perimeter thereof by rectangular sides is presented. A first slot is cut in a first rectangular side and a second slot in a second rectangular side in opposition to the first rectangular such that the first and second slots are parallel. A transluscent sheet having a top edge and a bottom edge and bearing a design is then inserted through the first and said second slots. The top and bottom edges of the sheet are then adhered to the first and second rectangular sides of the glass block by adhesive means.

While particular embodiments of the present invention have been illustrated and described, it would be obvious to those skilled in the art that various other changes and modifications can be made without departing from the spirit and scope of the invention. The important feature of the present invention is that it provides a means for making a decorative glass block having a decorative insert panel affixed thereto wherein the adhesive joint between the decorative panel and the (prior art) glass block is not visible through either the front or rear surface of the block. It is therefore intended to cover in the appended claims all such changes and modifications that are within the scope of this invention.

What I claim is:

1. A method for making a decorative glass block bearing a design comprising the steps of:
(a) presenting a prior art hollow glass block comprising a front surface, a rear surface parallel to said front surface wherein said front surface is identical to said rear surface, and rectangular sides disposed between and supporting said front and rear surfaces; then
(b) cutting said rectangular sides to separate said prior art hollow glass block into two semiblocks, each of two semiblocks being a mirror image of the other; then
(c) inserting a transluscent sheet bearing a design between said semiblocks and adhering said sheet to said two semiblocks by adhesive means.

2. A method for making a decorative glass block bearing a design comprising the steps of:
(a) presenting a prior art hollow glass block comprising a front surface, a rear surface parallel to said front surface wherein said front surface is identical to said rear surface, and rectangular sides disposed between and supporting said front and rear surfaces; then
(b) cutting a first slot in a first rectangular side and a second slot in a second rectangular side in opposition to said first rectangular side wherein said first and second slots are parallel; then
(c) inserting a transluscent sheet having a top edge and a bottom edge and bearing a design thereon through said first and said second slots and adhering said top and bottom edges of said sheet to said first and second rectangular sides of said glass block by adhesive means.
